(19) United States
(12) Patent Application Publication
(10) Pub. No.: US 2016/0262559 A1
(43) Pub. Date: Sep. 15, 2016

(54) VESSEL WHICH IS EASY TO OPEN AND CLOSE AND HAS METERING FUNCTION

(71) Applicant: Yong Un KIM, Busan (KR)

(72) Inventor: Yong Un KIM, Busan (KR)

(21) Appl. No.: 15/161,296

(22) Filed: May 23, 2016

Related U.S. Application Data
(63) Continuation of application No. PCT/KR2014/005328, filed on Jun. 18, 2014.

(30) Foreign Application Priority Data
Nov. 30, 2013 (KR) 10-2013-0148078
Jan. 2, 2014 (KR) 10-2014-0000153

(51) Int. Cl. A47G 19/34; G01F 11/00; B65D 23/00; A47G 19/24; B65D 1/16

(52) U.S. Cl. CPC A47G 19/34; A47G 19/24; B65D 1/16; B65D 23/003; G01F 11/003

(57) ABSTRACT

Disclosed is a vessel which is easy to open and close and has a metering function, comprising a containing part configured to accommodate contents therein; a mount fixed to an installation surface and configured to locate the containing part; and fixing means formed in one pair of members which are installed at each of the containing part and the mount to be connected with each other, wherein the containing part is fixed to the mount by the fixing means in a downward direction of the mount.

### CROSS REFERENCE TO RELATED APPLICATIONS

This application is a Continuation Application of PCT International Application No. PCT/KR2014/005328 filed on Jun. 18, 2014, which claims priority to Korean Patent Application Nos. 10-2013-0148078 filed on Nov. 30, 2013, and 10-2014-0000153 filed on Jan. 2, 2014 which are all hereby incorporated by reference in their entirety.

### BACKGROUND

The present invention relates to a kitchen vessel which is easy to open and close and has a metering function, and more particularly, to a kitchen vessel which is easy to open and close and has a metering function to allow seasonings such as salt, sugar and condiments to be used conveniently while cooking.

The present invention relates to a kitchen vessel which accommodates various seasonings for raising food taste, and has a metering function to allow only a necessary amount of seasoning to be used conveniently while cooking or eating, or to allow a required amount of coffee, creamer and sugar to be metered without a spoon.

Generally, there are various kinds of seasonings used to raise food taste, such as salt, sugar, dried red pepper powder and condiments. For classification of the seasonings and ease of use, the seasonings are separately stored using seasoning vessels.

In a “rotary support for a seasoning vessel” disclosed in Korean U.M. Publication No. 1999-014300, there has been proposed a technique in which a user may easily find a desired seasoning, and may also easily install the rotary support at any desired position such as a table, a sink, a shelf and a wall, and thus may store the seasoning vessel in which a seasoning is accommodated. Also, due to a beautiful shape of the invention, an exterior of a kitchen may be decorated more decorously.

However, in the prior art, it is difficult to take out the seasoning from the seasoning vessel while cooking. For example, when the user seasons vegetables with condiments while wearing vinyl gloves, or is holding a pot lid with his/her hand, the user may not easily add the seasoning.

Also, in a mount for a kitchen vessel which is easy to open and close and has a metering function according to a related art, there is a problem that an installation type thereof is designated only one, and thus it is difficult to adjust a position of the seasoning vessel according to user convenience.

And while food is cooked, various kinds of seasonings are used, and a required amount of each of the seasonings is different from each other. Therefore, it is inconvenient for cookers to meter the required amount of each of the seasonings using metering spoons whenever the seasonings are added.

In this connection, an “amount controllable seasoning vessel” disclosed in Korean Patent Publication No. 10-2008-0010248 relates to adjusting of an output amount of the seasoning vessel in which salt or sugar is accommodated, and proposes a technique in which the output amount is adjusted while two upper and lower plates in the seasoning vessel are overlapped with each other. In this technique, the two plates are located in a lid of the seasoning vessel, and an overlapping degree thereof is changed according to movement of a switch, and thus the output amount is adjusted.

However, this prior art does not provide a metering function which precisely meters an amount of the seasoning, like the metering spoons.

### SUMMARY

The present invention is directed to providing a new type of a kitchen vessel which is easy to open and close, has a metering function, and is installed in various types to store a seasoning vessel.

Also, the present invention is directed to providing a new type of a kitchen vessel which is easy to open and close, and has a metering function like a metering spoon to allow seasoning to be accurately metered while a structural change of a seasoning vessel having a normal bottle shape is minimized.

Also, the present invention is directed to providing a new type of an apparatus having a metering function in which, when creamer or sugar is added to coffee, a desired amount thereof is adjusted and then directly added into a coffee cup, and thus it is possible to solve a conventional sanitary problem in which a spoon adhered with coffee is put in a sugar or creamer vessel when the sugar or the creamer is added using the spoon, and a solidification phenomenon occurs due to liquid, and ingredients are mixed, and thus lumps are generated.

Therefore, the present invention is directed to providing a new type of a kitchen vessel which is easy to open and close, has a metering function, and is installed in various types to store a seasoning vessel.

Also, the present invention is directed to providing a new type of a kitchen vessel which is easy to open and close, has a metering function, and enables a seasoning vessel to be hooked to a mount in a direction of a lid and thus to be separated downward.

Also, the present invention is directed to providing a new type of a kitchen vessel which is easy to open and close, and has a metering function like a metering spoon to allow seasoning to be accurately metered while a structural change of a seasoning vessel having a normal shape is minimized.

According to the kitchen vessel which is easy to open and close, and has the metering function, a seasoning vessel 14 is fixed to a mount 12 by fixing means 16 such as magnets 60 and 62 which are connected to each other, and thus an installation position of the mount 12 may be freely located, and various positions such as a wall surface of a kitchen, a front wall surface of a sink, a top or front surface of the sink, or a top of a table can be used as the installation surface, and the mount 12 can be fixed thereto, and can be used conveniently. Also, the seasoning vessel 14 can be attached in a downward direction of the mount 12, and then can be caught by the mount 12. Therefore, the seasoning vessel 14 can be used in a pulling-down method, thereby enhancing convenience. Particularly, in the present invention, while a head 50 which is applied as a lid is fixed to the mount 12 by a stop recess 28 formed at the mount 12 and a latching protrusion 54 formed at the seasoning vessel 14, a barrel 40 of the seasoning vessel 14 can be pulled out, and thus a user can easily use the seasoning with one hand while cooking.

Also, since metering grooves 41 having various sizes can be formed at a metering member 40, the seasoning can be accurately metered, like metering spoons. Also, since various seasonings can be used without opening of a cover member 50, it is possible to provide convenience to the user while cooking.

### BRIEF DESCRIPTION OF THE DRAWINGS

FIG. 1 is a view illustrating a kitchen vessel which is easy to open and close and has a metering function according to a technical spirit of the present invention.

FIG. 2 is a view illustrating a state in which a seasoning vessel is hooked to a mount in the kitchen vessel which is easy to open and close and has the metering function according to the technical spirit of the present invention.

FIG. 3 is a view illustrating an example of an external appearance of a seasoning vessel in a kitchen vessel which is easy to open and close and has a metering function according to a preferable embodiment of the present invention.

FIG. 4 is a cross-sectional view of the seasoning vessel of FIG. 3.

FIG. 5 is a view illustrating an example of an external appearance of a mount in the kitchen vessel which is easy to open and close and has the metering function according to the preferable embodiment of the present invention.

FIG. 6 is a cross-sectional view of the mount of FIG. 5 taken along a central axis of a seating groove in which the seasoning vessel is coupled.

FIG. 7 is a view illustrating a case in which the kitchen vessel is installed at an upper surface of the sink.

FIG. 8 is a view illustrating the kitchen vessel which is easy to open and close and has the metering function according to the technical spirit of the present invention.

FIG. 9 is a view illustrating an action of a cover part in the kitchen vessel which is easy to open and close and has the metering function according to the technical spirit of the present invention.

FIG. 10 is a view illustrating an action of a metering member in the kitchen vessel which is easy to open and close and has the metering function according to the technical spirit of the present invention.

FIG. 11 is an exploded perspective view of the kitchen vessel which is easy to open and close and has the metering function according to the preferable embodiment of the present invention.

FIG. 12 is a cross-sectional view of the kitchen vessel which is easy to open and close and has the metering function according to the preferable embodiment of the present invention.

FIG. 13 is a view detailedly illustrating the metering member in the kitchen vessel which is easy to open and close and has the metering function according to the preferable embodiment of the present invention.

FIG. 14 is an assembled cross-sectional view of the cover part in the kitchen vessel which is easy to open and close and has the metering function according to the preferable embodiment of the present invention.

FIG. 15 is a view illustrating other examples of a fixing element of a rotary cover and a fixed cover of the cover part of FIG. 14.

FIG. 16 is a view detailedly illustrating the rotary cover in the cover part of FIG. 14.

FIG. 17 is a view detailedly illustrating the fixed cover in the cover part of FIG. 14.

FIG. 18 is a view illustrating an operation state of the kitchen vessel which is easy to open and close and has the metering function according to the preferable embodiment of the present invention.

### DETAILED DESCRIPTION

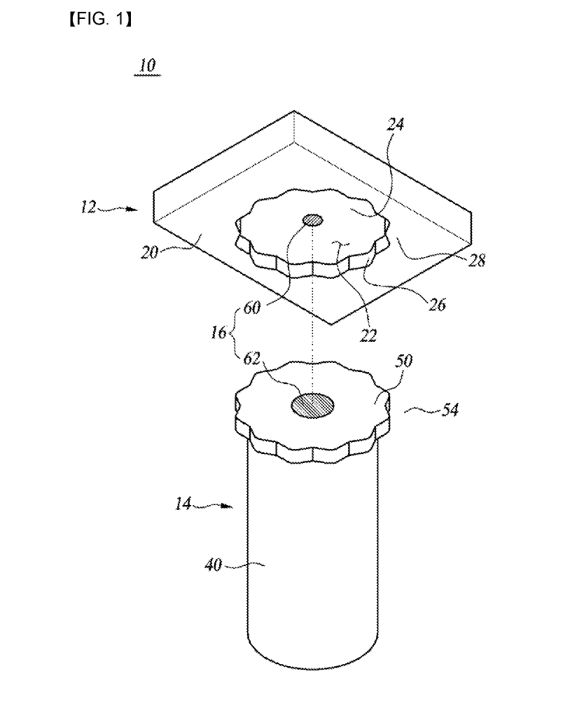

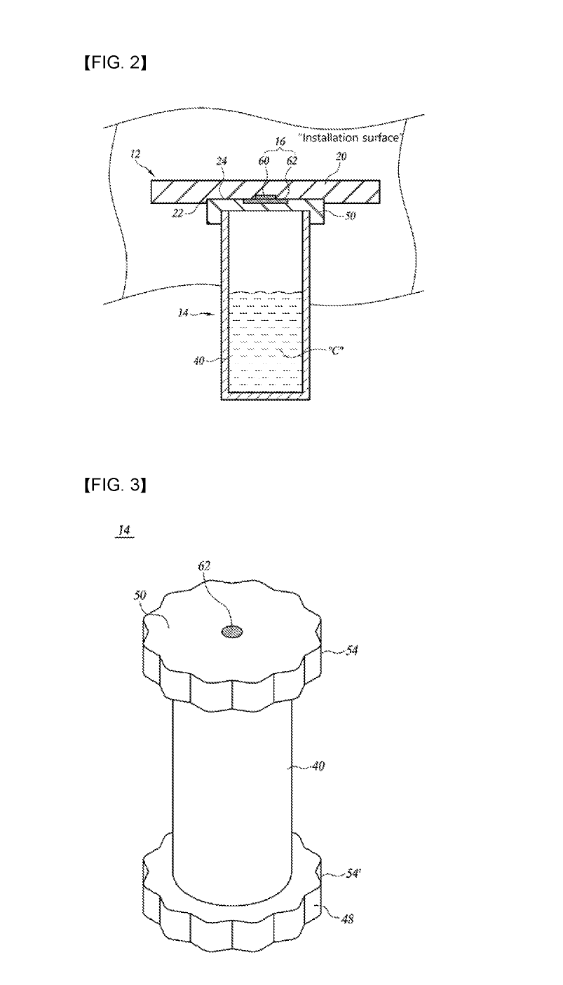

FIG. 1 is a view illustrating a kitchen vessel which is easy to open and close and has a metering function according to a technical spirit of the present invention, and FIG. 2 is a view illustrating a state in which a seasoning vessel is hooked to a mount in the kitchen vessel which is easy to open and close and has the metering function according to the technical spirit of the present invention.

Referring to FIGS. 1 and 2, a kitchen vessel 10 which is easy to open and close and has a metering function according to the present invention includes a mount 12, a seasoning vessel 14 and fixing means 16. Since the seasoning vessel 14 is fixed to the mount 12 by the interconnecting fixing means 16, an installation position of the mount 12 may be freely moved, and thus the mount 12 may be fixed and used conveniently on installation surfaces located at various positions such as a wall of the kitchen, a front wall surface of a sink, a top or front surface of the sink, or a top of a table. Here, the seasoning vessel 14 accommodates a seasoning therein. The mount 12 is fixed to the installation surface, and locates the seasoning vessel 14. The fixing means 16 include one pair of members which are installed at the seasoning vessel 14 and the mount 12, respectively, and interconnect them. By such fixing means 16, the seasoning vessel 14 is fixed to the mount 12 in a downward direction of the mount 12.

In the present invention, the fixing means 16 include a first magnet 60 and a second magnet 62, and the seasoning vessel 14 may be fixed to the mount 12 in the downward direction of the mount 12 by attaching the first magnet 60 and the second magnet 62 to each other, and thus the seasoning vessel 14 may be attached in the downward direction of the mount 12, and may be located to be caught in the mount 12, and then may be pulled and used, and thus use convenience is enhanced. Here, the first magnet 60 is installed at the mount 12, and the second magnet 62 is installed at the seasoning vessel 14, and the first magnet 60 and the second magnet 62 are attached to each other.

In the kitchen vessel 10 which is easy to open and close and has the metering function according to the present invention, the fixing means 16 may have a mechanical fixing mechanism or an electric/electronic fixing mechanism, instead of the magnet. For example, the preferable embodiment of the present invention has used the magnets to simplify a structure and to easily manufacture, but a coupling structure which is provided variously may be applied, and thus various types of fixing means 16 may be provided. And the present invention includes not only the magnets but also a metallic material which is attached to the magnets. That is, the first magnet 60 may be used as the fixing means 16, and the second magnet 62 may be the magnet which is attached to the first magnet 60 or the metallic material which is attached to the first magnet 60. Accordingly, in the preferable embodiment of the present invention, a metallic lid may be used as the second magnet 62.

Also, in the kitchen vessel 10 which is easy to open and close and has the metering function according to the present invention, like the preferable embodiment of the present invention, the mount 12 has a main recess 22, and a stop recess 28, and the seasoning vessel 14 has a head 50 which is formed to be inserted into the main recess 22 and the stop recess 28, and thus the seasoning vessel 14 is prevented from being undesirably rotated while being located at the mount 12. Here, the main recess 22 is formed by a bottom surface 24 and a circumferential surface 26 to have a predetermined depth, such that one end of the seasoning vessel 14 is inserted, and the stop recess 28 is formed to protrude outside from the circumferential surface 26 of the main recess 22. And the head 50 is one end which is inserted into the main recess 22.

Also, in the kitchen vessel 10 which is easy to open and close and has the metering function according to the present invention, like the preferable embodiment of the present invention, the seasoning vessel 14 has a barrel 40 in which the seasoning is accommodated. And the head 50 of the seasoning vessel 14 has a latching protrusion 54 which is inserted into the stop recess 28, and is used as a lid of the seasoning vessel 14 which is locked on or released from the barrel 40 by rotation with respect to the barrel 40. In the kitchen vessel 10 which is easy to open and close and has the metering function according to the present invention, by such a configuration, when a user grips and rotates the barrel 40 in a circumferential direction, and then pulls down the barrel 40, the head 50 is maintained in an attached state to the mount 12, and thus the lid is separated, and only the opened barrel 40 is pulled out. Accordingly, the user may easily use the seasoning with one hand.

In a structure of the present invention in which the head 50 of the seasoning vessel 14 is caught when the seasoning vessel 14 is rotated, the main recess 22 and the stop recess 28 may have various structures. That is, in the preferable embodiment of the present invention, each of corners of the main recess 22 is formed to have a function of the stop recess 28 through various structures such as a hexagonal or dodecagonal shape, a flower shape, a protruding shape, an embedding shape and an elliptical shape, and thus a burden which should separately form the stop recess 28 and the latching protrusion 54 may be removed. However, the basic spirit of the present invention may also allow a structure having an irregular shape, as illustrated in FIG. 1.

Meanwhile, in the present invention, the head 50 applied to the seasoning vessel 14 may be the lid 50 of the seasoning vessel 14, as described in the preferable embodiment of the present invention, or may be a dummy head 48 which is integrally formed with the barrel 40 at a side opposite to a portion to which the lid 50 is coupled, and may be a term which includes all elements which is rotatable separately from the barrel 40, like the lid 50, and which is rotatable integrally with the barrel 40. In this case, the head 50 which is rotatable separately from the barrel 40 is an element, like the lid 50, which opens and closes, or may be an element which is required to be rotated (i.e., which does not open and close, like the lid 50, but which is allowed to be rotated for setting a rotational direction or the like when being rotated by the user). The head 50 in this case may be usefully applied to a method in which the seasoning vessel 14 is attached in a direction toward a lower side of the mount 12. And unlike the lid 50, the dummy head 48 which is the head 50 integrally rotated with the barrel 40 may be usefully applied to the case in which the mount 14 is used without rotation while being put on the table or the sink.

Also, in the present invention, methods which are variously applied in the art, other than the structure described in the preferable embodiment of the present invention, may be used as a method of fixing the mount 14 to the installation surface.

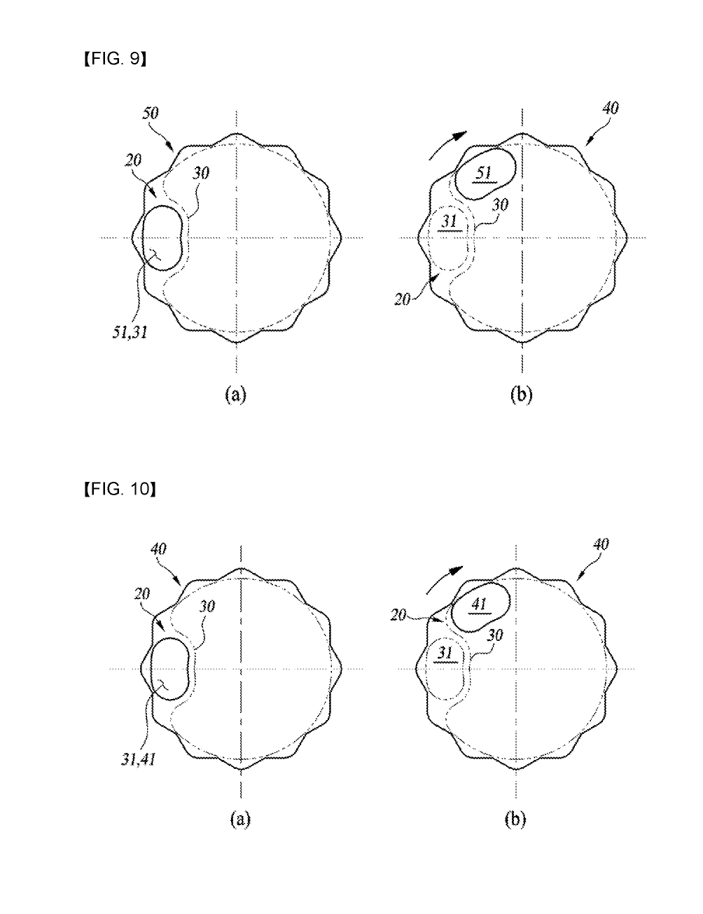

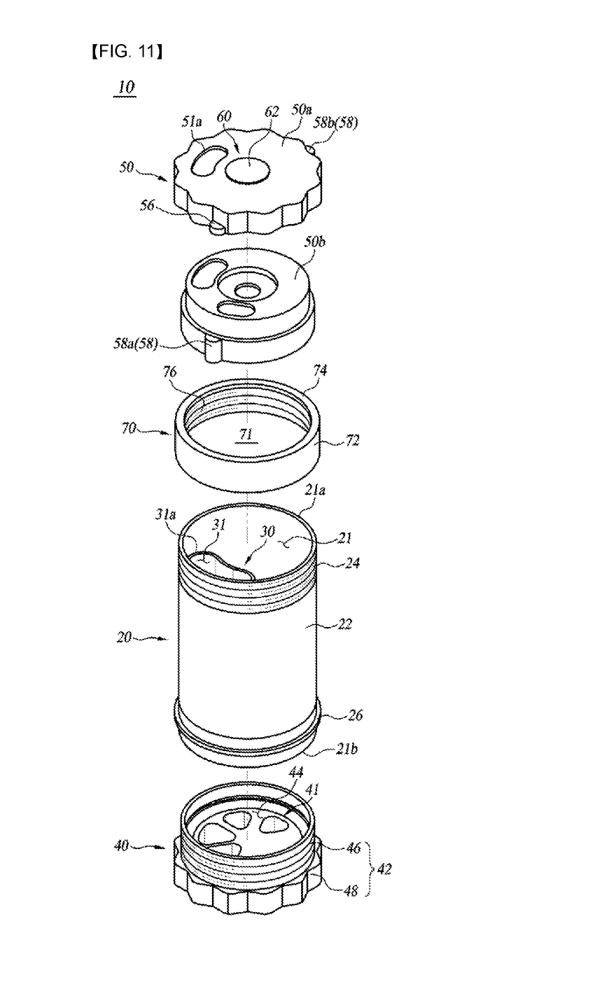

Meanwhile, FIG. 8 is a view illustrating the kitchen vessel which is easy to open and close and has the metering function according to the technical spirit of the present invention. And FIG. 9 is a view illustrating an action of a cover part in the kitchen vessel which is easy to open and close and has the metering function according to the technical spirit of the present invention, and FIG. 10 is a view illustrating an action of a metering member in the kitchen vessel which is easy to open and close and has the metering function according to the technical spirit of the present invention.

Referring to FIG. 8, the kitchen vessel 10 which is easy to open and close and has the metering function according to the present invention includes a barrel 20, a metering member 40, and a cover member 50. Since a large-sized or complicated device configuration is excluded, a change in a structure of the seasoning vessel having a normal bottle shape may be minimized, and an original using state and function of the seasoning vessel may be maintained, and thus the seasoning vessel may be used in a bottle shape while being put on a cooking table or the table, and may also provide a function of metering the seasoning, thereby increasing use convenience.

At this time, the barrel 20 has a middle body 22 forming an internal space 21 in which the seasoning is accommodated, and also has a discharge tube 30 which forms a discharge path 31 isolated from the internal space 21 in the middle body 22. It is preferable that the barrel 20 be formed by injection-molding a transparent synthetic resin so that the middle body 22 and the discharge tube 30 are integrally formed. However, in the barrel 20, the middle body 22 and the discharge tube 30 may be separately formed of a material such as glass, and then may be coupled to each other. And the embodiment has described an example in which the barrel 20 has a circular cross section with respect to a central axis, but the cross section of the barrel 20 may have various shapes.

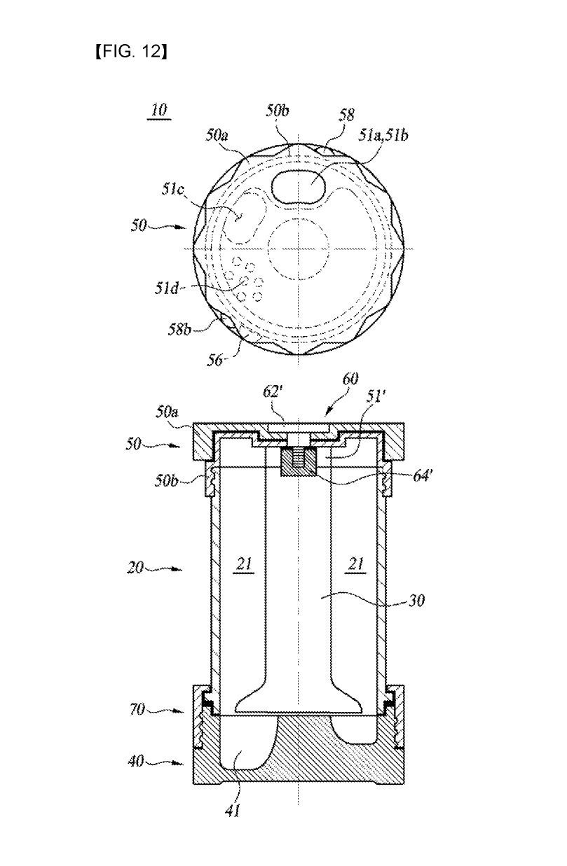

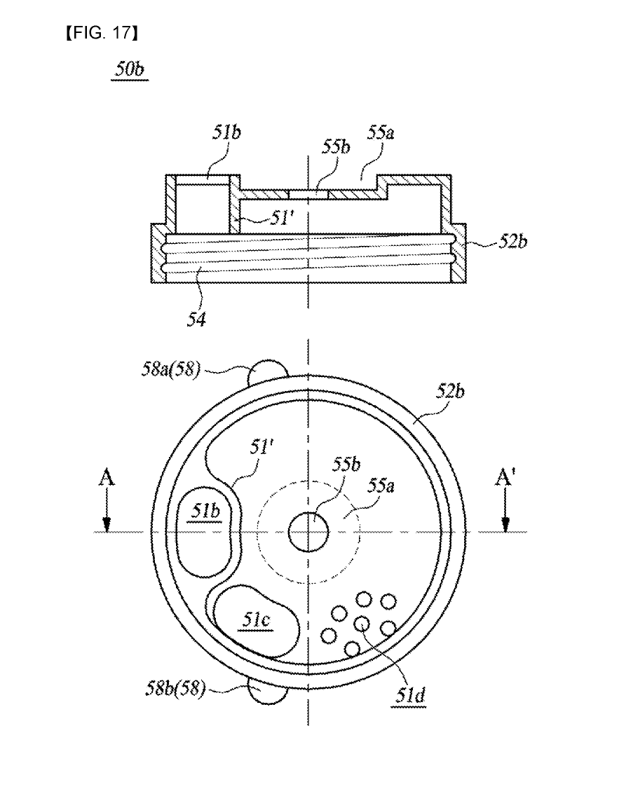

The metering member 40 has a bottom body 42 which is rotatably coupled to a lower side of the barrel 20, and also has a metering groove 41 in which a predetermined amount of seasoning is accommodated and which is aligned with a location of the discharge path 31 through rotation of the bottom body 42. As illustrated in FIG. 10, the metering member 40 has a position (FIG. 10a) which is aligned with the discharge path 31 of the barrel 20 through rotation of the bottom body 42 and allows the seasoning to be discharged to an outside, or has a position (FIG. 10b) which is misaligned with the discharge path 31 and prevents the seasoning from being discharged to the outside. In the metering member 40, like the preferable embodiment of the present invention, a plurality of metering grooves 41 are formed at a bottom surface 44 in a circumferential direction, and the metering groove 41 in which a necessary amount of seasoning is accommodated is aligned with the discharge path 31 by turning the bottom body 42, and thus accurate metering may be enabled. Also, in the embodiment of the present invention, the metering member 40 is rotatably coupled to the barrel 20 by applying a fixing ring 70 (referring to FIGS. 11 and 17). However, a technique for rotatably coupling the metering member 40 to the barrel 20 may be realized by not only a shape similar to the cover member 50 but also shapes which are variously applied in the art.

The cover member 50 has a top body 52 which is rotatably coupled to an upper side of the barrel 20, and also has a discharge hole 51 which is aligned with the location of the discharge path 31 through rotation of the top body 52. As illustrated in FIG. 9, the cover member 50 has a position (FIG. 9a) which is aligned with the discharge path 31 of the barrel 20 by the rotation of the top body 52 so that the seasoning which is metered by the metering member 40 and moved to the discharge path 31 is discharged to the outside, or has a position (FIG. 9b) which is misaligned with the discharge path 31 and prevents the seasoning from being discharged to the outside. The cover member 50 may be formed in a single configuration, and may also formed to have a dual structure which includes a rotary cover 50a and a fixed cover 50b like in the preferable embodiment of the present invention so that the metered amount of seasoning is used, like the present invention, or a large or small amount of seasoning is discharged, like a general seasoning vessel, thereby enhancing the user convenience.

### EMBODIMENTS OF THE INVENTION

Hereinafter, the preferable embodiment of the present invention will be described in detail with reference to FIGS. 3 to 11.

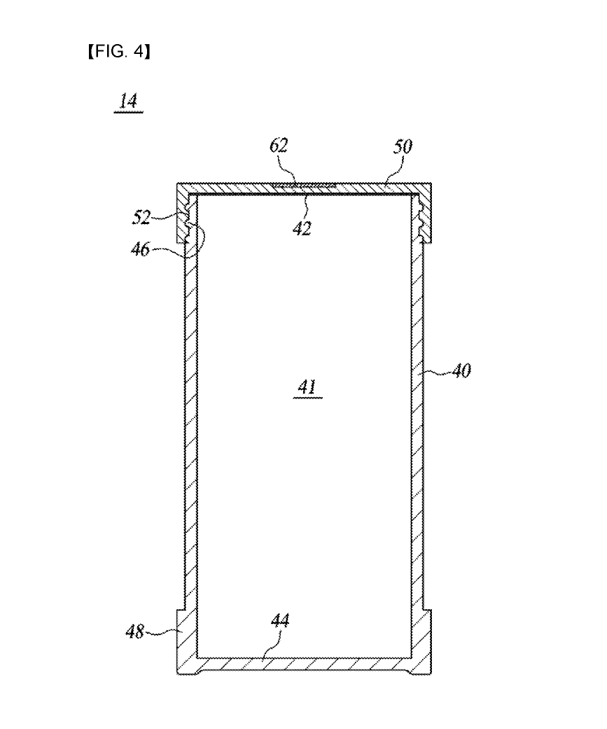

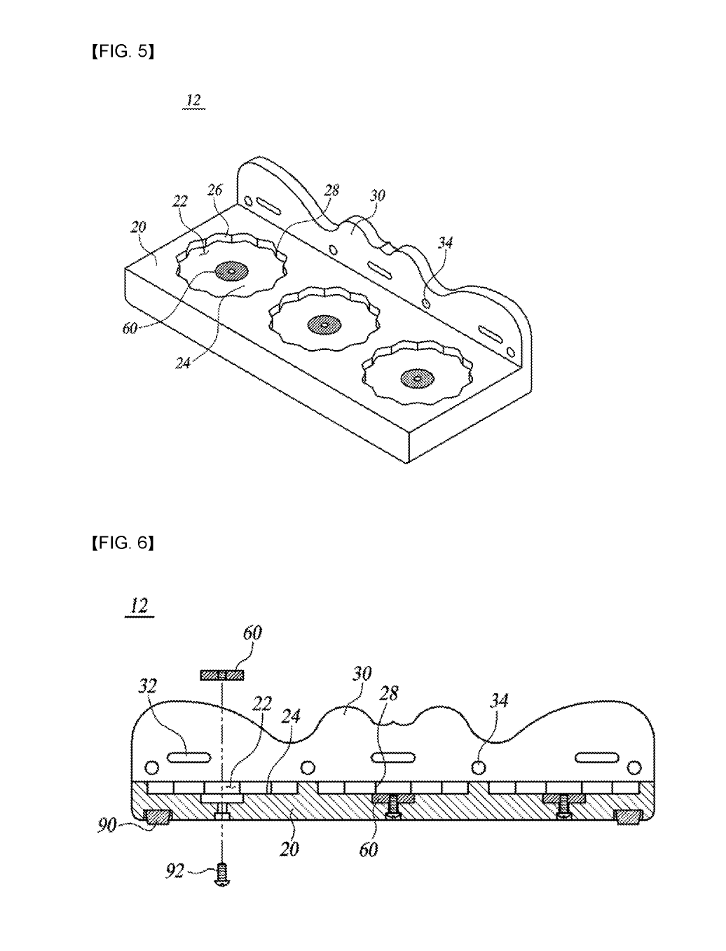

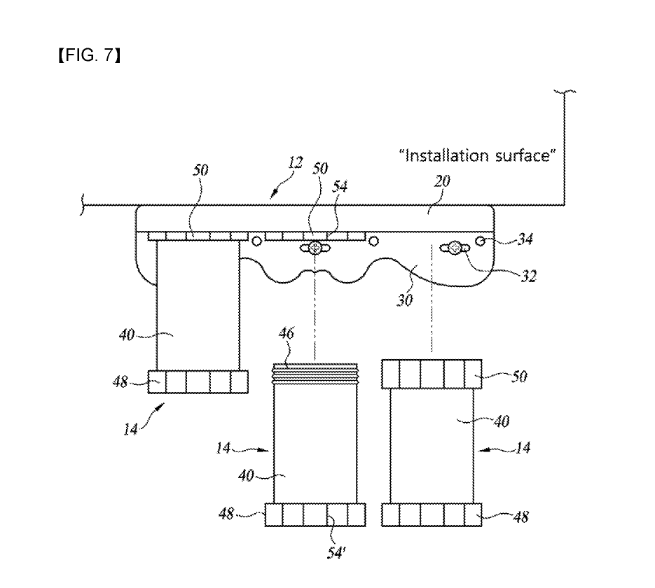

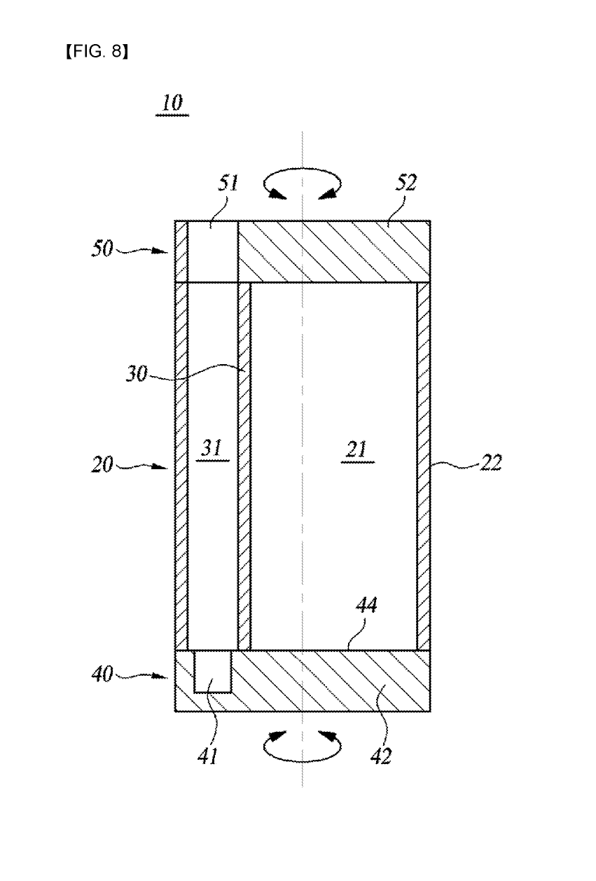

FIG. 3 is a view illustrating an example of an external appearance of a seasoning vessel in a kitchen vessel which is easy to open and close and has a metering function according to a preferable embodiment of the present invention, and FIG. 4 is a cross-sectional view of the seasoning vessel of FIG. 3. And FIG. 5 is a view illustrating an example of an external appearance of a mount in the kitchen vessel which is easy to open and close and has the metering function according to the preferable embodiment of the present invention, and FIG. 6 is a cross-sectional view of the mount of FIG. 5 taken along a central axis of a seating groove in which the seasoning vessel is coupled. Also FIG. 7 is a view illustrating a case in which the kitchen vessel is installed at an upper surface of the sink.

First, referring to FIGS. 5 and 6, the mount 12 of the kitchen vessel 10 (referring to FIGS. 1 and 2, hereinafter the same) which is easy to open and close and has the metering function according to the preferable embodiment of the present invention has a horizontal plate 20, and a vertical plate 30 which is integrally formed with or coupled to a rear side of the horizontal plate 20. The horizontal plate 20 has a main recess 22, which is formed in a predetermined depth by a bottom surface 24 and a circumferential surface 26, so as to locate the seasoning vessel 14 on an upper surface of the horizontal plate 20, and also has a stop recess 28 which is formed to protrude outward from the circumferential surface 26 of the main recess 22. And a support rubber 90 which prevents the horizontal plate 20 from being pushed back when the horizontal plate 20 is put on a floor surface is installed at a lower surface of the horizontal plate 20. A hole 34 to which a suction plate fixed to the installation surface is coupled and a hole 32 to which a screw fixed to a wall surface is coupled are formed at the vertical plate 30. Here, various techniques which are generally applied by those skilled in the art may be used as a configuration for fixing the mount 12.

The mount 12 is fixed to the installation surface, and as illustrated in FIG. 7, the mount 12 is fixed to the installation surface so that the seasoning vessel 14 is attached downward.

The first magnet 60 of the fixing means 16 (referring to FIGS. 1 and 2, hereinafter the same) is fixed to the mount 12. In the embodiment, the first magnet 60 is installed at the horizontal plate 20 by a bolt 92 so that a height thereof corresponds to the bottom surface 24 of the main recess 22. Of course, various methods for installing an attachment at a plastic object may be used as such an installation method of the first magnet 60.

Referring to FIGS. 3 and 4, the seasoning vessel 14 of the kitchen vessel 10 which is easy to open and close and has the metering function according to the preferable embodiment of the present invention accommodates the seasoning and is located at the mount 12.

The seasoning vessel 14 includes the barrel 40 and the head 50. At this time, an opening 42 is formed at the barrel 40 in an upward direction of the bottom surface 44, and a space 41 which accommodates the seasoning is formed therein, and a screw thread 46 is formed at an upper outer circumference thereof. And the dummy head 48 is installed at a lower end of the barrel 40. Like the upper head 50 serving as the lid, the dummy head 48 has a latching protrusion 54′, and allows the seasoning vessel 14 to be easily positioned when the seasoning vessel 14 is located at the mount 12, and prevents the seasoning vessel 14 from being undesirably in disorder.

In addition to the above-described dummy head 48, the head 50 of the seasoning vessel 14 is rotatably coupled to the barrel 40, and is formed to be inserted into the main recess 22 of the mount 12 and also to have the latching protrusion 54 which is inserted into the stop recess 28. In the embodiment, the head 50 is the lid of the seasoning vessel 14 in which a screw thread 52 fastened to the screw thread 46 of the barrel 40 is formed at a lower side thereof. When the barrel 40 is rotated while the lid 50 is located at the mount 12, the lid 50 is maintained in a stopped state by the mount 12, and thus separated from the barrel 40. Accordingly, the user may grip and rotate the barrel 40 with one hand, and thus may pull out the barrel 40 from the mount 12 while the lid 50 is opened, and may use the seasoning.

The second magnet 62 of the fixing means 16 is installed at the seasoning vessel 14. In the embodiment, the second magnet 62 may be the head 50 which is formed to contain iron content, or may be formed by inserting a magnet attached to the first magnet 60 into the head 50.

In the kitchen vessel 10 which is easy to open and close and has the metering function according to the preferable embodiment of the present invention, the seasoning vessel 14 is fixed to the mount 12 in a downward direction of the mount 12 by the first and second magnets 60 and 62 as the fixing means 16 formed in one pair to be installed at the seasoning vessel 14 and the mount 12, respectively, and to be connected to each other, as illustrated in FIG. 7.

And as illustrated in FIG. 8, by a configuration in which the head 50 used as the lid is caught by the mount 12 so as not to be rotated, the barrel 40 may be separated while the lid is opened, and thus the seasoning may be used. Accordingly, it is convenient to use the seasoning with one hand while cooking. At this point, the first seasoning vessel 14 from a left side of FIG. 7 shows a state which is located at the mount 12, and the second seasoning vessel 14 shows a state in which the user rotates the barrel 40 so that the head 50 is separated from the barrel 40, and thus the barrel 40 is pulled out downward, and the third seasoning vessel 14 shows a state in which, when the user does not rotate the barrel 40, but pulls the barrel 40 downward, the seasoning vessel 14 is separated from the mount 12 while the lid is closed.

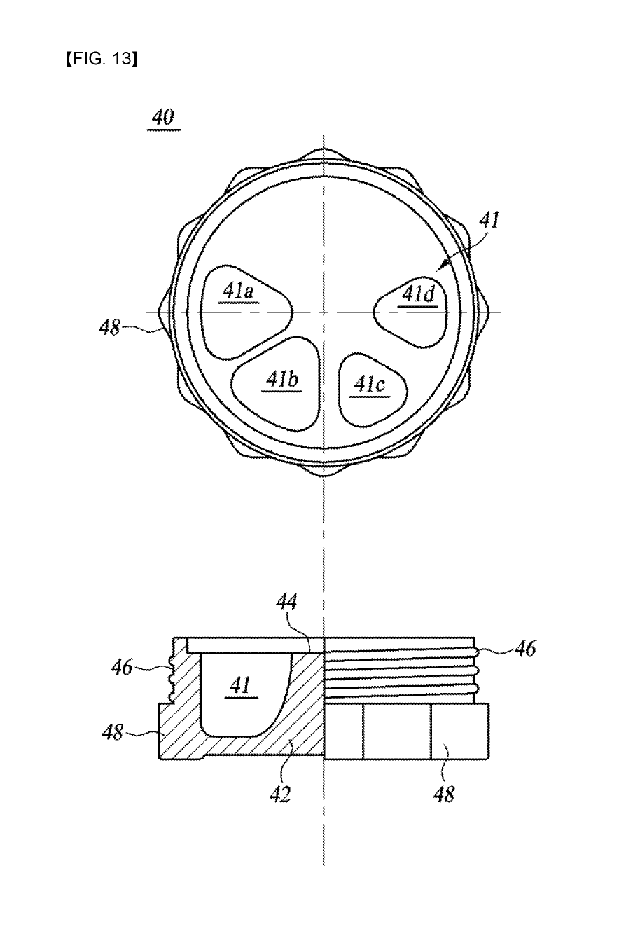

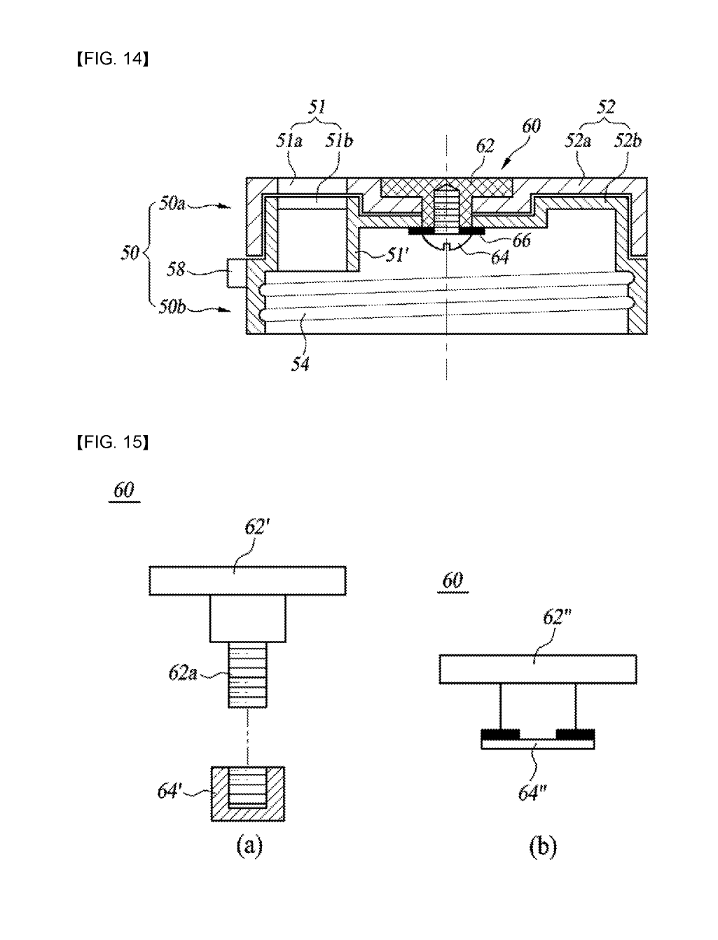

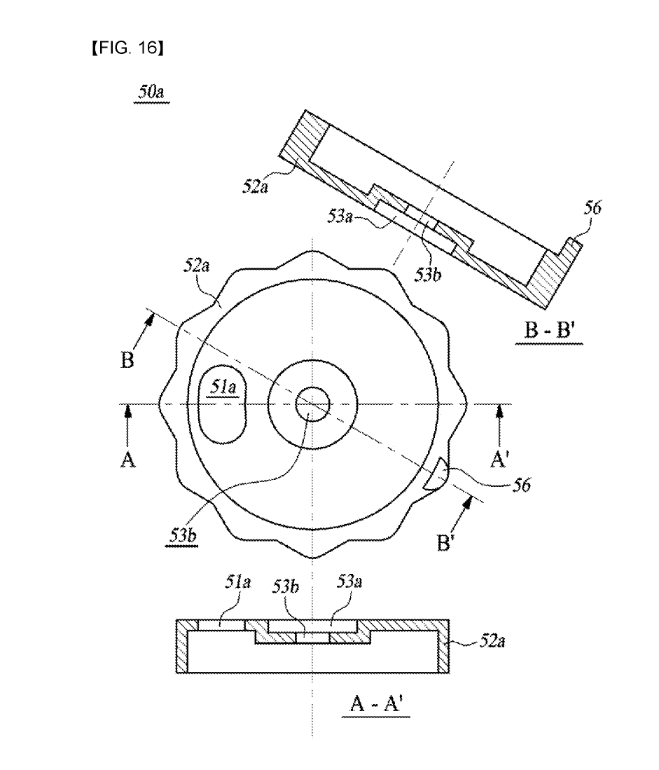

FIG. 11 is an exploded perspective view of the kitchen vessel which is easy to open and close and has the metering function according to the preferable embodiment of the present invention, FIG. 12 is a cross-sectional view of the kitchen vessel which is easy to open and close and has the metering function according to the preferable embodiment of the present invention. And FIG. 13 is a view detailedly illustrating the metering member in the kitchen vessel which is easy to open and close and has the metering function according to the preferable embodiment of the present invention, FIG. 14 is an assembled cross-sectional view of the cover part in the kitchen vessel which is easy to open and close and has the metering function according to the preferable embodiment of the present invention, FIG. 15 is a view illustrating other examples of a fixing element of a rotary cover and a fixed cover of the cover part of FIG. 14. And FIG. 16 is a view detailedly illustrating the rotary cover in the cover part of FIG. 14, and FIG. 17 is a view detailedly illustrating the fixed cover in the cover part of FIG. 14.

Referring to FIGS. 11 and 12, the kitchen vessel 10 which is easy to open and close and has the metering function according to the preferable embodiment of the present invention includes the barrel 20, the metering member 40, the cover member 50 and the fixing ring 70 so as to allow the seasoning to be accurately metered like using a metering spoon and also to allow the various amounts of seasoning to be used without opening of the cover member 50, thereby enhancing user convenience.

In the embodiment, the cover member 50 includes the rotary cover 50a and the fixed cover 50b so that the metered amount of seasoning may be used, like the present invention, and the large or small amount of seasoning may also be used, like the general seasoning vessel, and thus convenience in separation and cleaning are enhanced together with the user convenience.

In the kitchen vessel 10 which is easy to open and close and has the metering function according to the preferable embodiment of the present invention, as illustrated in FIG. 11, the barrel 20 has the middle body 22 forming the internal space 21 in which the seasoning is accommodated, and also has the discharge tube 30 which forms the discharge path 31 isolated from the internal space 21 in the middle body 22.

At this point, the barrel 20 is penetrated from an upper end 21a to a lower end 21b, and a screw thread 24 is formed at an upper outer circumferential surface thereof, and the cover member 50 is coupled and fixed thereto. And a latching flange 26 is formed at a lower outer circumferential surface of the barrel 20, and thus the fixing ring 70 which enables the metering member 40 to be rotatable while being in close contact with the barrel 20 is hooked thereto.

The discharge tube 30 which forms the discharge path 31 at the barrel 20 is penetrated from an upper end 31a to a lower end 31b, and has an enlarged portion 32 forming the discharge path 31 of which a lower side is wider than an upper side, and thus enables the metered seasoning to be stably moved.

In the kitchen vessel 10 which is easy to open and close and has the metering function according to the preferable embodiment of the present invention, the metering member 40 has the bottom body 42 which is rotatably coupled to the lower side of the barrel 20, and the metering groove 41 in which the predetermined amount of seasoning is accommodated and which is aligned with the location of the discharge path 31 through the rotation of the bottom body 42 is formed at the bottom surface 44 thereof. The metering member 40 is rotatably coupled to the barrel 20 by the fixing ring 70.

Here, the fixing ring 70 includes a body 72 in which a through-hole 71 is formed, a latching rim 72 which is formed at an upper end of the body 72 to be caught by the latching flange 26 formed at the lower outer circumferential surface of the barrel 20, and an internal screw thread 76 which is formed so that the metering member 40 is screwed in an inner surface of the body 72. By the fixing ring 70, the metering member 40 is rotatably coupled to and caught by the fixing ring 70 while being in close contact with the barrel 20.

As illustrated in FIG. 13, in the metering member 40, an external screw thread 46 which is fastened to the internal screw thread 76 of the fixing ring 70 is formed at an upper outer circumferential surface of the body 42, and a handle 48 which enables the user to easily grip and rotate the metering member 40 is formed at a lower side thereof. In the embodiment, when the mount (not shown) is formed so that an outer circumferential surface thereof has a corner and thus the kitchen vessel 10 which is easy to open and close and has the metering function according to the preferable embodiment of the present invention is installed at a wall surface or the like, the handle 48 enables the user to rotate the metering member 40 while the kitchen vessel 10 is located at the mount.

Also, the metering groove 41 of the metering member 40 includes a plurality of sub-metering grooves 41a, 41b, 41c and 41d which are sequentially arranged in a circumferential direction so that the same amount of seasoning is accommodated in every two of them. Each of the sub-metering grooves 41a, 41b, 41c and 41d has a capacity of 3.25 cc (¼ tablespoon; 41a and 41b) and 1.25 cc (¼ teaspoon; 41c and 41d), and thus the amount of seasoning may be accurately adjusted in every two grooves.

41a (3.75 cc)+0 cc=3.75 cc (¼ tablespoon)

41a (3.75 cc)+41b (3.75 cc)=7.5 cc (½ tablespoon)

41b (3.75 cc)+41c (1.25 cc)=5 cc (1 teaspoon)

41c (1.25 cc)+41d (1.25 cc)=2.5 cc (½ teaspoon)

41d (1.25 cc)+0 cc=1.25 cc (¼ teaspoon)

Of course, if necessary, the number and the capacity of sub-metering grooves 41a, 41b, 41c and 41d may be set variously.

In the kitchen vessel 10 which is easy to open and close and has the metering function according to the embodiment, the cover member 50 has the top body 52 which is rotatably coupled to the upper side of the barrel 20, and also has the discharge hole 51 which is aligned with the location of the discharge path 31 through the rotation of the top body 52. Particularly, in the embodiment, the cover member 50 has the dual structure which includes the rotary cover 50a and the fixed cover 50b so that the metered amount of seasoning is used, like the present invention, or the large or small amount of seasoning is discharged, like a general seasoning vessel, thereby enhancing the user convenience.

As illustrated in FIG. 14, the rotary cover 50a and the fixed cover 50b of the cover member 50 may be rotatably coupled by a fixing unit 60 including a fixing plate 62, a bolt 64 and a washer 66, and thus may control a discharge of the seasoning. Of course, the fixing unit 60 which enables the rotary cover 50a to be rotatable while the rotary cover 50a is coupled to the fixed cover 50b may be applied in various types, as illustrated in FIG. 14. For example, FIG. 15a illustrates an example of the fixing unit 60 in which a bolt 62a is formed at a fixing plate 62′, and which enables the rotary cover 50a to be rotatable while the rotary cover 50a is coupled to the fixed cover 50b using a nut 64′ fastened to the bolt 62a, as illustrated in FIG. 12. And FIG. 15b illustrates an example in which a latching rim 64″ by which the rotary cover 50a and the fixed cover 50b are caught is formed by pressing an extension portion of a fixing plate 62″.

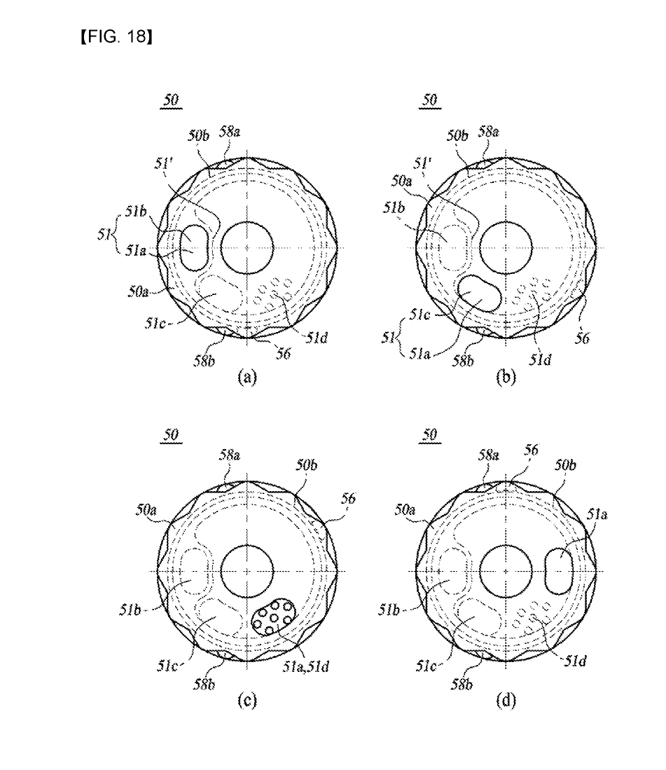

In the embodiment, as illustrated in FIG. 16, the rotary cover 50a of the cover member 50 is rotatably coupled to the fixed cover 50b, and has an external discharge hole 51a which is aligned with an internal discharge hole 51b of the fixed cover 50b when being rotated. A fixing plate accommodation groove 53a and a through-hole 56b are formed on a central axis of an upper surface of the rotary cover 50a to couple the fixing unit 60 for fixing with the fixed cover 50b. And in the embodiment, the rotary cover 50a has a stopper which stops rotation of the rotary cover 50a when the external discharge hole 51a is aligned with a position of the internal discharge hole 51b of the fixed cover 50b (i.e., a state of FIG. 18a) and when the external discharge hole 51a is in a blocked state (i.e., a state of FIG. 18d). In the embodiment, the stopper includes an upper stopper 26 which is formed at the rotary cover 50a, and a lower stopper 58 which is formed at the fixed cover 50b, and the upper stopper 26 is formed to protrude to a lower side of a body 52a of the rotary cover 50a, and disposed between the lower stoppers 58 to restrict rotation thereof.

Meanwhile, in the kitchen vessel 10 which is easy to open and close and has the metering function according to the embodiment, when the mount (not shown) which allows the kitchen vessel 10 which is easy to open and close and has the metering function according to the present invention to be hung on a wall surface or the like is formed by an outer circumferential surface of the body 52a of the rotary cover 50a formed to have a corner, the metering member 40 or the rotary cover 50a may be rotated while the seasoning vessel 14 is located at the mount.

In the embodiment, the fixed cover 50b of the cover member 50 has a cover discharge tube 51′ which is disposed at a position aligned with the discharge tube 30 when the fixed cover 50b is coupled and fixed to the barrel 20, and also has the internal discharge hole 51b which is formed at an upper side of the cover discharge tube 51′ to be opened. A fixing plate accommodation groove 55a and a through-hole 55b are formed on a central axis of an upper surface of the fixed cover 50b to couple the fixing unit 60 for fixing with the rotary cover 50a. An internal screw thread 54 is formed at a lower inner surface of the body 52a, and fastened to the screw thread 24 formed at an upper side of the middle body 22 of the barrel 20.

In the embodiment, the fixed cover 50b has sub-discharge holes 51c and 51d which are spaced apart from the internal discharge hole 51b and sequentially arranged in a circumferential direction, and thus enables the seasoning metered by the metering groove 41 of the metering member 40 to be used when the external discharge hole 51a of the rotary cover 50a is aligned with the position of the internal discharge hole 51b of the fixed cover 50b, and also enables the seasoning accommodated in the internal space 21 of the barrel 20 to be used when the external discharge hole 51a of the rotary cover 50a is aligned with the sub-discharge holes 51c and 51d of the fixed cover 50b. At this point, in the embodiment, the sub-discharge holes 51c and 51d include an open hole-shaped first sub-discharge hole 51c, and a partially blocked second sub-discharge hole 51d. However, the number and shapes of the sub-discharge holes 51c and 51d may be variously changed according to a manufacturer or user's selection.

Also, in the kitchen vessel 10 which is easy to open and close and has the metering function according to the embodiment, the fixed cover 50b is associated with the rotary cover 50a, and has the lower stopper 58 corresponding to the upper stopper 26 of the rotary cover 50a so as to stop the rotation of the rotary cover 50a when the external discharge hole 51a of the rotary cover 50a is aligned with the position of the internal discharge hole 51b of the fixed cover 50b and when the external discharge hole 51a of the rotary cover 50a is in the blocked state. At this point, the lower stopper 58 needs two stopping positions, and thus includes a first lower stopper 58a and a second lower stopper 58b, and the rotary cover 50a and the fixed cover 50b are coupled to each other so that the upper stopper 26 of the rotary cover 50a is disposed between the first lower stopper 58a and the second lower stopper 58b, and thus the rotation of the rotary cover 50a may be blocked at each of the positions.

FIG. 18 is a view illustrating an operation state of the kitchen vessel which is easy to open and close and has the metering function according to the preferable embodiment of the present invention.

Referring to FIG. 18, the kitchen vessel 10 which is easy to open and close and has the metering function according to the preferable embodiment of the present invention may allow the metered amount of seasoning to be discharged, or may allow the large or small amount of to be discharged, like the general seasoning vessel, through four use types, thereby enhancing the use convenience. That is, FIGS. 18a to 18d illustrate the use types such as discharge of a predetermined amount, continuous discharge of a large amount, continuous discharge of a small amount, and blocking of the discharge.

Specifically, FIG. 18a illustrates a state in which the external discharge hole 51a of the rotary cover 50a and the internal discharge hole 51b of the fixed cover 50b are aligned with a position of the discharge path 31 of the barrel 20. In this case, the seasoning in the metering groove 41 located at the discharge path 31 is discharged to the outside by rotation of the bottom body 42. FIG. 18b illustrates a state in which the external discharge hole 51a of the rotary cover 50a is aligned with the open hole-shaped first sub-discharge hole 51c. In this case, the discharge path 31 is blocked, and the seasoning accommodated in the internal space 21 of the barrel 20 is discharged to the outside, and thus the large amount of seasoning may be continuously used. FIG. 18c illustrates a state in which the external discharge hole 51a of the rotary cover 50a is aligned with the partially blocked second sub-discharge hole 51d. In this case, the discharge path 31 is blocked, and the seasoning accommodated in the internal space 21 of the barrel 20 is discharged to the outside, thus the large amount of seasoning which is smaller than the amount of seasoning in FIG. 12b may be continuously used. FIG. 18d illustrates a state in which the external discharge hole 51a of the rotary cover 50a is blocked, and the seasoning is not discharged, and the seasoning vessel is in a storing state of the seasoning.

Although a few embodiments of the present invention have been shown and described, it would be appreciated by those skilled in the art that changes may be made in these embodiments without departing from the principles and spirit of the invention, the scope of which is defined in the claims and their equivalents.

1-12. (canceled)

13. A vessel which is easy to open and close and has a metering function, comprising:
a containing part configured to accommodate contents therein;
a mount fixed to an installation surface and configured to locate the containing part; and
fixing means formed in one pair of members which are installed at each of the containing part and the mount to be connected with each other,
wherein the containing part is fixed to the mount by the fixing means in a downward direction of the mount.

14. The vessel of claim 13, wherein the fixing means comprise a first magnet which is installed at the mount and a second magnet which is installed at the containing part, and the first magnet and the second magnet are attached to each other, and thus the containing part is fixed to the mount in the downward direction of the mount.

15. The vessel of claim 13, wherein the mount comprises a main recess which is formed to have a predetermined depth by a bottom surface and a circumferential surface, such that one end of the containing part is inserted therein, and a stop recess which is formed to protrude outward from the circumferential surface of the main recess, and one end of the containing part which is inserted into the main recess has a head which is formed to be inserted into the main recess and the stop recess.

16. The vessel of claim 15, wherein the containing part has a barrel in which the contents are accommodated, and the head of the containing part has a latching protrusion which is inserted into the stop recess, and is used as a lid of the containing part which is locked to or released from the barrel by rotation with respect to the barrel, and when a user grips and turns the barrel in a circumferential direction, and then pulls it down, the head is maintained in an attached state to the mount, and the lid is separated, and only the opened barrel is pulled out.

17. A vessel which is easy to open and close and has a metering function, comprising:
a mount fixing to an installation surface, and comprising a main recess which is formed to have a predetermined depth by a bottom surface and a circumferential surface, and a stop recess which is formed to protrude outward from the circumferential surface of the main recess; and
a containing part configured to accommodate contents, and located at the mount,
wherein the containing part comprises a barrel which has a space to accommodate the contents therein, and a head which is rotatably coupled to the barrel, and formed to be inserted into the main recess of the mount, and has a latching protrusion inserted into the stop recess, and when the barrel is rotated in a state in which the containing part is located at the mount, the head is maintained in a stopped state by the mount.

18. The vessel of claim 17, further comprising fixing means formed in one pair of members which are installed at each of the containing part and the mount to be connected with each other, such that the containing part is fixed to the mount by the fixing means in a downward direction of the mount.

19. The vessel of claim 18, wherein the fixing means comprise a first magnet which is installed at the mount and a second magnet which is installed at the containing part, and the first magnet and the second magnet are attached to each other, and thus the containing part is fixed to the mount in the downward direction of the mount.

20. A vessel which is easy to open and close and has a metering function, comprising:
a barrel having a middle body which forms an internal space in which contents are accommodated, and a discharge tube which forms a discharge path isolated from the internal space in the middle body;
a metering member having a bottom body which is rotatably coupled to a lower side of the barrel, and a metering groove which accommodates a predetermined amount of contents and is aligned with a position of the discharge path through rotation of the bottom body; and
a cover member having a top body which is rotatably coupled to an upper side of the barrel, and a discharge hole which is aligned with the position of the discharge path through rotation of the top body,
wherein the contents which are metered by the metering groove of the metering member is discharged to the discharge hole of the cover member through the discharge path of the barrel.

21. The vessel of claim 20, wherein the metering groove of the metering member comprises a plurality of sub-metering grooves which are sequentially arranged in a circumferential direction and formed to have the same size or different sizes and thus to accommodate a predetermined amount of contents in each of them.

22. The vessel of claim 20, wherein the cover member comprises a fixed cover having a cover discharge tube which is disposed at a position aligned with the discharge tube when being fixed to the barrel and an internal discharge hole which is formed at an upper side of the cover discharge tube to be opened, and a rotary cover which is rotatably coupled to the fixed cover and has an external discharge hole which is aligned with the internal discharge hole when being rotated, and the fixed cover has sub-discharge holes which are spaced apart from the internal discharge hole and sequentially arranged in a circumferential direction, and thus enables the contents metered by the metering groove of the metering member to be used when the external discharge hole of the rotary cover is aligned with a position of the internal discharge hole of the fixed cover, and also enables the contents accommodated in the internal space of the barrel to be used when the external discharge hole of the rotary cover is aligned with the sub-discharge holes of the fixed cover.

23. The vessel of claim 22, wherein the rotary cover and the fixed cover further comprise a stopper which stops rotation of the rotary cover when the external discharge hole of the rotary cover is aligned with the position of the internal discharge hole of the fixed cover and when the external discharge hole of the rotary cover is in a blocked state.

24. The vessel of claim 22, wherein each of the rotary cover and the metering member is formed so that an outer circumferential surface thereof has a corner.
